(19) United States
(12) Patent Application Publication
(10) Pub. No.: US 2006/0187339 A1
(43) Pub. Date: Aug. 24, 2006

(54) Apparatus and method for controlling image quality and sound field in digital format broadcasting

(76) Inventor: Byong Yong Kong, Icheon (KR)

Correspondence Address: PARK LAW FIRM, 3255 WILSHIRE BLVD, SUITE 1110, LOS ANGELES, CA, 90010, US

(21) Appl. No.: 11/136,021

(22) Filed: May 24, 2005

(30) Foreign Application Priority Data
Feb. 21, 2005 (KR) 10-2005-0013976

(51) Int. Cl. H04N 11/02

(52) U.S. Cl. 348/423.1

(57) ABSTRACT

The present invention discloses an apparatus for controlling an image quality and a sound field in digital format broadcasting, including a first encoder unit for generating digital audio/video codes by encoding audio/video service signals according to a preset audio/video encoding method, a second encoder unit for generating digital data codes by encoding data service signals according to a preset data encoding method, a multiplexer for generating digital data by multiplexing the digital audio/video codes and the digital data codes according to a preset multiplexing method, a transmission multiplexer for generating bit streams by multiplexing the digital data, service information, multiplexer information, and optimum sound field information and optimum image quality information in the digital format broadcasting according to a preset multiplexing method, and a digital format broadcast modulator for modulating the bit streams according to a transmission method of the digital format broadcasting, and transmitting the modulated bit streams through an antenna.

### TECHNICAL FIELD

The present invention relates to an apparatus and method for digital format broadcasting, and more particularly to, an apparatus and method for controlling an image quality and a sound field in digital format broadcasting.

### BACKGROUND ART

FIG. 1 is a block diagram illustrating an internal structure of a conventional apparatus for transmitting digital format broadcasting.

Referring to FIG. 1, the conventional apparatus for transmitting the digital format broadcasting includes an audio/video encoder 111, a data encoder 113, channel encoders 115 and 117, a multiplexer 119, a transmission multiplexer 121, a digital format broadcast modulator 123 and an antenna 125.

Audio/video service signals intended to be broadcasted in the digital format broadcasting are transmitted to the audio/video encoder 111, and data service signals intended to be broadcasted in the digital format broadcasting are transmitted to the data encoder 113. The audio/video encoder 111 generates digital audio/video codes by encoding the audio/video service signals according to a preset audio/video encoding method, and outputs the generated codes to the channel encoder 115. The data encoder 113 generates digital data codes by encoding the data service signals according to a preset data encoding method, and outputs the generated codes to the channel encoder 117.

The channel encoder 115 channel-encodes the digital audio/video codes from the audio/video encoder 111 according to a preset channel encoding method, and outputs the generated codes to the multiplexer 119. The channel encoding method of the channel encoder 115 can be an interleaving method in a time domain for preventing a burst error. The channel encoder 117 channel-encodes the digital data codes from the data encoder 113 according to a preset channel encoding method, and outputs the generated codes to the multiplexer 119. In addition, the channel encoding method of the channel encoder 117 can be an interleaving method in a time domain for preventing a burst error.

The multiplexer 119 multiplexes the output signals from the channel encoders 115 and 117, and outputs the resultant signals to the transmission multiplexer 121. Here, the output signals from the multiplexer 119 are defined as digital data. The transmission multiplexer 121 multiplexes the digital data from the multiplexer 119, service information and multiplexer information, and outputs the multiplexed data to the digital format broadcast modulator 123. The multiplexing method of the transmission multiplexer 121 can be an interleaving method in a frequency domain for preventing a burst error. The service information means information on services provided in the digital format broadcasting. For example, the service information can be a type, singer and title of broadcasted music in the broadcasting service using digital transmission, such as a digital satellite digital multimedia broadcasting (DMB) service, a ground wave DMB service, a satellite radio service and a satellite television service.

The digital format broadcast modulator 123 modulates bit streams from the transmission multiplexer 121 according to a transmission method of a digital format method, and transmits the modulated bit streams through the antenna 125.

The internal structure of the conventional apparatus for transmitting the digital format broadcasting has been explained with reference to FIG. 1. An internal structure of a conventional apparatus for receiving digital format broadcasting will now be described with reference to FIG. 2.

FIG. 2 is a block diagram illustrating the internal structure of the conventional apparatus for receiving the digital format broadcasting.

As illustrated in FIG. 2, the conventional apparatus for receiving the digital format broadcasting includes an antenna 211, a tuner 213, a digital format broadcast de-modulator 215, a channel decoder 217, an audio/video decoder 219, a data decoder 221 and a microcomputer 223.

The signals transmitted from the apparatus for transmitting the digital format broadcasting as shown in FIG. 1 are received by the apparatus for receiving the digital format broadcasting through the antenna 211. The antenna 211 outputs the received signals to the tuner 213. The tuner 213 tunes the signals from the antenna 211, and outputs the tuned signals to the digital format broadcast de-modulator 215. The digital format broadcast de-modulator 215 de-modulates the signals according to a reception method corresponding to the transmission method of the digital format broadcast modulator 123 of the apparatus for transmitting the digital format broadcasting, namely, a reception method of the digital format method. Here, the digital format broadcasting de-modulator 215 de-multiplexes the signals from the apparatus for transmitting the digital format broadcasting into digital data, service information and multiplexer information.

The digital data are transmitted to the channel decoder 217. The channel decoder 217 generates digital audio/video codes and digital data codes by channel-decoding the digital data according to a preset channel decoding method, namely, a channel decoding method corresponding to the channel encoding method of the channel encoders 115 and 117 of the apparatus for transmitting the digital format broadcasting, outputs the digital audio/video codes to the audio/video decoder 219, and outputs the digital data codes to the data decoder 221.

The audio/video decoder 219 outputs audio/video service signals by decoding the digital audio/video codes from the channel decoder 217 according to a preset audio/video decoding method, namely, an audio/video decoding method corresponding to the audio/video encoding method of the audio/video encoder 111 of the apparatus for transmitting the digital format broadcasting. The data decoder 221 outputs data service signals by decoding the digital data codes from the channel decoder 217 according to a preset data decoding method, namely, a data decoding method corresponding to the data encoding method of the data encoder 113 of the apparatus for transmitting the digital format broadcasting.

On the other hand, the microcomputer 223 controls the whole operations of the tuner 213, the digital format broadcast de-modulator 215, the channel decoder 217, the audio/video decoder 219 and the data decoder 221.

As explained with reference to FIGS. 1 and 2, the conventional apparatuses for transmitting and receiving the digital format broadcasting do not transmit or receive image quality information or sound field information. Accordingly, when watching the digital format broadcasting, an audience must directly control an image quality and a sound field. For example, when the audience watching the digital format broadcasting provided by a first service provider intends to watch the digital format broadcasting provided by a second service provider, the optimum image quality and sound field in the digital format broadcasting provided by the first service provider may be different from those in the digital format broadcasting provided by the second service provider. Therefore, the audience must inconveniently directly set the optimum image quality and sound field in the digital format broadcasting provided by the second service provider.

### DISCLOSURE OF THE INVENTION

The present invention is achieved to solve the above problems. An object of the present invention is to provide an apparatus and method for controlling an image quality and a sound field in digital format broadcasting.

Another object of the present invention is to provide an apparatus and method for providing an optimum image quality and an optimum sound field by adding optimum image quality and sound field information to digital format broadcasting.

In order to achieve the above-described objects of the invention, there is provided an apparatus for controlling an image quality and a sound field in digital format broadcasting, including: a first encoder unit for generating digital audio/video codes by encoding audio/video service signals according to a preset audio/video encoding method; a second encoder unit for generating digital data codes by encoding data service signals according to a preset data encoding method; a multiplexer for generating digital data by multiplexing the digital audio/video codes and the digital data codes according to a preset multiplexing method; a transmission multiplexer for generating bit streams by multiplexing the digital data, service information, multiplexer information, and optimum sound field information and optimum image quality information in the digital format broadcasting according to a preset multiplexing method; and a digital format broadcast modulator for modulating the bit streams according to a transmission method of the digital format broadcasting, and transmitting the modulated bit streams through an antenna.

According to another aspect of the present invention, an apparatus for controlling an image quality and a sound field in digital format broadcasting includes: a digital format broadcast de-modulator for generating digital data, service information, multiplexer information, and optimum sound field information and optimum image quality information in the digital format broadcasting, by de-modulating received signals according to a de-modulation method of the digital format broadcasting corresponding to a transmission method of the digital format broadcasting; a channel decoder for generating digital audio/video codes and digital data codes by channel-decoding the digital data according to a preset channel decoding method; a digital signal processor/image quality controller for controlling an image quality of the digital video codes according to the optimum image quality information, and controlling a sound field of the digital audio codes according to the optimum sound field information; a video decoder for outputting video service signals by decoding the digital video codes controlled by the optimum image quality information according to a preset video decoding method; an audio decoder for outputting audio service signals by decoding the digital audio codes controlled by the optimum sound field information according to a preset audio decoding method; and a data decoder for outputting data service signals by decoding the digital data codes according to a preset data decoding method.

According to yet another aspect of the present invention, an apparatus for controlling an image quality and a sound field in digital format broadcasting includes: a first encoder unit for generating digital audio/video codes by encoding audio/video signals according to a preset audio/video encoding method; a second encoder unit for generating digital data codes by encoding data service signals according to a preset data encoding method; a multiplexer for generating digital data by multiplexing the digital audio/video codes and the digital data codes according to a preset multiplexing method; a transmission multiplexer for generating bit streams by multiplexing the digital data, service information and multiplexer information according to a preset multiplexing method; and a digital format broadcast modulator for modulating the bit streams according to a transmission method of the digital format broadcasting, and transmitting the modulated bit steams through an antenna.

According to yet another aspect of the present invention, an apparatus for controlling an image quality and a sound field in digital format broadcasting includes: a digital format broadcast de-modulator for generating digital data, service information and multiplexer information by de-modulating received signals according to a de-modulation method of the digital format broadcasting corresponding to a transmission method of the digital format broadcasting; a channel decoder for generating digital audio/video codes and digital data codes by channel-decoding the digital data according to a preset channel decoding method; a digital signal processor/image quality controller for controlling an image quality of the digital video codes according to the service information, and controlling a sound field of the digital audio codes according to the service information; a video decoder for outputting video service signals by decoding the digital video codes controlled by the service information according to a preset video decoding method; an audio decoder for outputting audio service signals by decoding the digital audio codes controlled by the service information according to a preset audio decoding method; and a data decoder for outputting data service signals by decoding the digital data codes according to a preset data decoding method.

According to yet another aspect of the present invention, a method for controlling an image quality and a sound field in digital format broadcasting includes the steps of: generating digital audio/video codes by encoding audio/video service signals according to a preset audio/video encoding method; generating digital data codes by encoding data service signals according to a preset data encoding method; generating digital data by multiplexing the digital audio/video codes and the digital data codes according to a preset multiplexing method; generating bit streams by multiplexing the digital data, service information, multiplexer information, and optimum sound field information and optimum image quality information in the digital format broadcasting according to a preset multiplexing method; and modulating the bit streams according to a transmission method of the digital format broadcasting, and transmitting the modulated bit streams through an antenna.

According to yet another aspect of the present invention, a method for controlling an image quality and a sound field in digital format broadcasting includes the steps of: generating digital data, service information, multiplexer information, and optimum sound field information and optimum image quality information in the digital format broadcasting, by de-modulating received signals according to a de-modulation method of the digital format broadcasting corresponding to a transmission method of the digital format broadcasting; generating digital audio/video codes and digital data codes by channel-decoding the digital data according to a preset channel decoding method; controlling an image quality of the digital video codes according to the optimum image quality information, and controlling a sound field of the digital audio codes according to the optimum sound field information; outputting video service signals by decoding the digital video codes controlled by the optimum image quality information according to a preset video decoding method; outputting audio service signals by decoding the digital audio codes controlled by the optimum sound field information according to a preset audio decoding method; and outputting data service signals by decoding the digital data codes according to a preset data decoding method.

According to yet another aspect of the present invention, a method for controlling an image quality and a sound field in digital format broadcasting includes the steps of: generating digital audio/video codes by encoding audio/video signals according to a preset audio/video encoding method; generating digital data codes by encoding data service signals according to a preset data encoding method; generating digital data by multiplexing the digital audio/video codes and the digital data codes according to a preset multiplexing method; generating bit streams by multiplexing the digital data, service information and multiplexer information according to a preset multiplexing method; and modulating the bit streams according to a transmission method of the digital format broadcasting, and transmitting the modulated bit steams through an antenna.

According to yet another aspect of the present invention, a method for controlling an image quality and a sound field in digital format broadcasting includes the steps of: generating digital data, service information and multiplexer information by de-modulating received signals according to a de-modulation method of the digital format broadcasting corresponding to a transmission method of the digital format broadcasting; generating digital audio/video codes and digital data codes by channel-decoding the digital data according to a preset channel decoding method; controlling an image quality of the digital video codes according to the service information, and controlling a sound field of the digital audio codes according to the service information; outputting video service signals by decoding the digital video codes controlled by the service information according to a preset video decoding method; outputting audio service signals by decoding the digital audio codes controlled by the service information according to a preset audio decoding method; and outputting data service signals by decoding the digital data codes according to a preset data decoding method.

### BRIEF DESCRIPTION OF THE DRAWINGS

The present invention will become better understood with reference to the accompanying drawings which are given only by way of illustration and thus are not limitative of the present invention, wherein:

FIG. 1 is a block diagram illustrating an internal structure of a conventional apparatus for transmitting digital format broadcasting;

FIG. 2 is a block diagram illustrating an internal structure of a conventional apparatus for receiving digital format broadcasting;

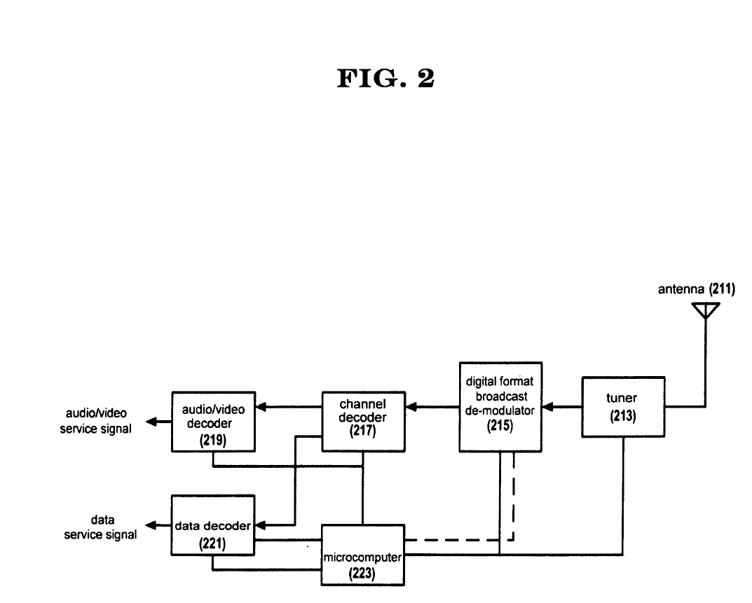

FIG. 3 is a block diagram illustrating an internal structure of an apparatus for transmitting digital format broadcasting in accordance with the present invention;

FIG. 4 is a block diagram illustrating an internal structure of a first apparatus for receiving digital format broadcasting in accordance with the present invention; and

FIG. 5 is a block diagram illustrating an internal structure of a second apparatus for receiving digital format broadcasting in accordance with the present invention.

### BEST MODE FOR CARRYING OUT THE INVENTION

An apparatus and method for controlling an image quality and a sound field in digital format broadcasting in accordance with the present invention will now be described in detail with reference to the accompanying drawings. Also, well-known functions or constructions are not described in detail since they would obscure the invention in unnecessary detail.

The present invention suggests an apparatus and method for controlling an image quality and a sound field in digital format broadcasting. Especially, the present invention suggests an apparatus and method for providing digital format broadcasting having an optimum image quality and sound field, by enabling an apparatus for transmitting digital format broadcasting to transmit optimum image quality and sound field information in digital format broadcasting, and enabling an apparatus for receiving digital format broadcasting to receive the optimum image quality and sound field information and automatically control an image quality and a sound field.

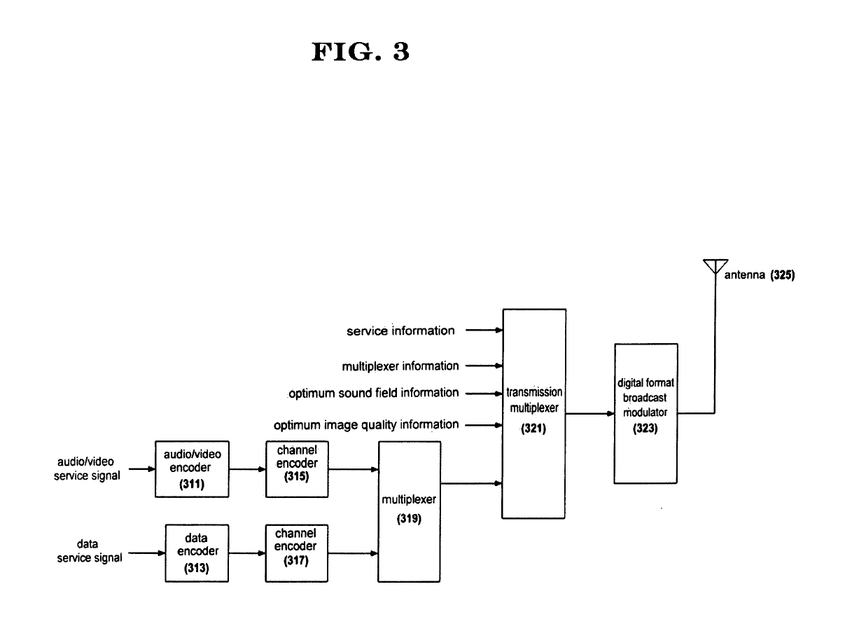

FIG. 3 is a block diagram illustrating an internal structure of an apparatus for transmitting digital format broadcasting in accordance with the present invention.

Referring to FIG. 3, the apparatus for transmitting the digital format broadcasting includes an audio/video encoder 311, a data encoder 313, channel encoders 315 and 317, a multiplexer 319, a transmission multiplexer 321, a digital format broadcast modulator 323 and an antenna 325.

Audio/video service signals intended to be broadcasted in the digital format broadcasting are transmitted to the audio/video encoder 311, and data service signals intended to be broadcasted in the digital format broadcasting are transmitted to the data encoder 313. The audio/video encoder 311 generates digital audio/video codes by encoding the audio/video service signals according to a preset audio/video encoding method, and outputs the generated codes to the channel encoder 315. The data encoder 313 generates digital data codes by encoding the data service signals according to a preset data encoding method, and outputs the generated codes to the channel encoder 317.

The channel encoder 315 channel-encodes the digital audio/video codes from the audio/video encoder 311 according to a preset channel encoding method, and outputs the generated codes to the multiplexer 319. The channel encoding method of the channel encoder 315 can be an interleaving method in a time domain for preventing a burst error. The channel encoder 317 channel-encodes the digital data codes from the data encoder 313 according to a preset channel encoding method, and outputs the generated codes to the multiplexer 319. In addition, the channel encoding method of the channel encoder 317 can be an interleaving method in a time domain for preventing a burst error.

The multiplexer 319 multiplexes the output signals from the channel encoders 315 and 317, and outputs the resultant signals to the transmission multiplexer 321. Here, the output signals from the multiplexer 319 are defined as digital data. The transmission multiplexer 321 multiplexes the digital data from the multiplexer 319, service information, multiplexer information, optimum sound field information and optimum image quality information, and outputs the multiplexed data to the digital format broadcast modulator 323. The multiplexing method of the transmission multiplexer 321 can be an interleaving method in a frequency domain for preventing a burst error. The service information means information on services provided in the digital format broadcasting. For example, the service information can be a type, singer and title of broadcasted music in the broadcasting service using digital transmission, such as a digital satellite DMB service, a ground wave DMB service, a satellite radio service and a satellite television service. The optimum sound field information and the optimum image quality information are newly added to notify an optimum sound field and an optimum image quality in signals transmitted by the apparatus for transmitting the digital format broadcasting.

The digital format broadcast modulator 323 modulates bit streams from the transmission multiplexer 321 according to a transmission method of a digital format method, and transmits the modulated bit streams through the antenna 325.

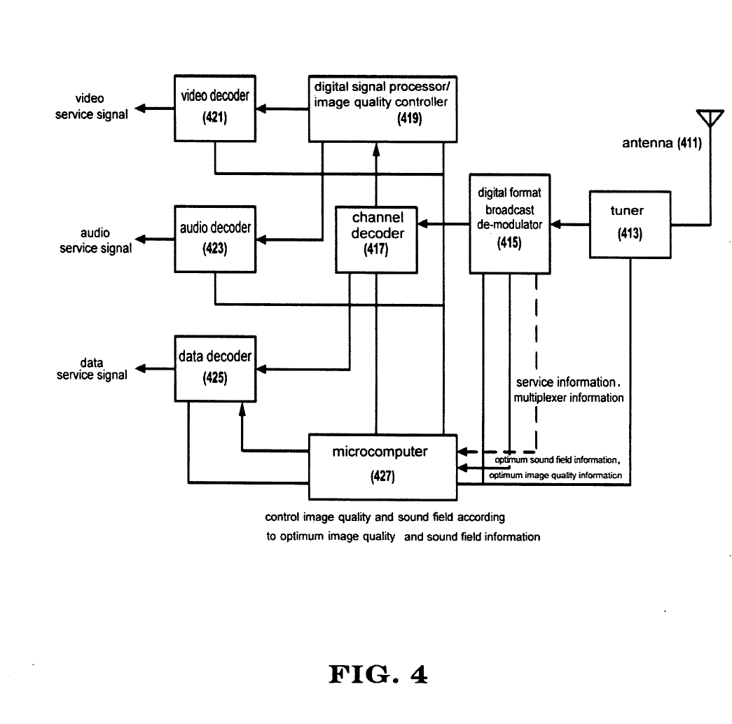

The internal structure of the apparatus for transmitting the digital format broadcasting has been explained with reference to FIG. 3. An internal structure of a first apparatus for receiving digital format broadcasting will now be described with reference to FIG. 4.

FIG. 4 is a block diagram illustrating the internal structure of the first apparatus for receiving the digital format broadcasting in accordance with the present invention.

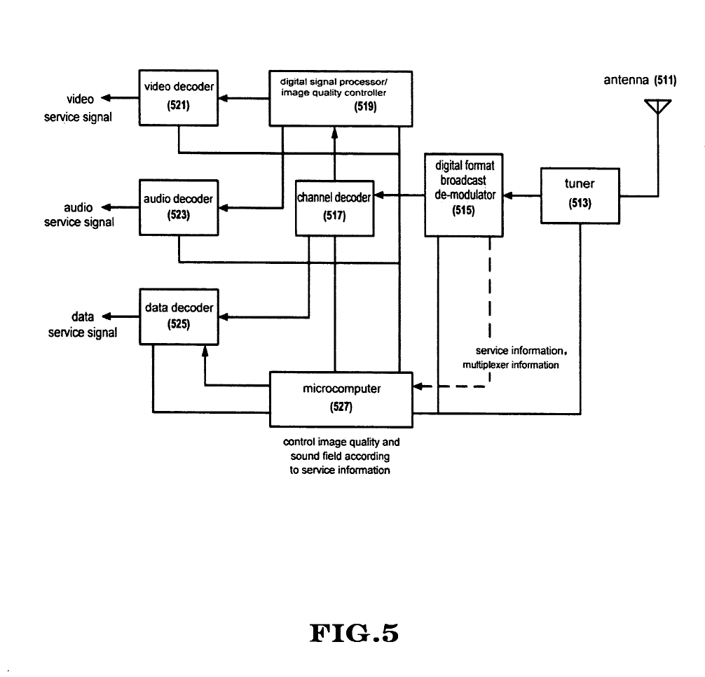

Here, the first apparatus for receiving the digital format broadcasting uses the optimum sound field information and the optimum image quality information transmitted by the apparatus for transmitting the digital format broadcasting as shown in FIG. 3, and a second apparatus for receiving digital format broadcasting that will be discussed later in FIG. 5 attains an optimum sound field and an optimum image quality without using the optimum sound field information and the optimum image quality information from the apparatus for transmitting the digital format broadcasting, namely, merely by using the service information of the conventional apparatus for transmitting the digital format broadcasting. The second apparatus for receiving the digital format broadcasting will later be explained in detail with reference to FIG. 5, and thus detailed explanations thereof are omitted.

As illustrated in FIG. 4, the first apparatus for receiving the digital format broadcasting includes an antenna 411, a tuner 413, a digital format broadcast de-modulator 415, a channel decoder 417, a digital signal processor/image quality controller 419, a video decoder 421, an audio decoder 423, a data decoder 425 and a microcomputer 427.

The signals transmitted from the apparatus for transmitting the digital format broadcasting as shown in FIG. 3 are received by the first apparatus for receiving the digital format broadcasting through the antenna 411. The antenna 411 outputs the received signals to the tuner 413. The tuner 413 tunes the signals from the antenna 411, and outputs the tuned signals to the digital format broadcast de-modulator 415. The digital format broadcast de-modulator 415 de-modulates the signals according to a reception method corresponding to the transmission method of the digital format broadcast modulator 423 of the apparatus for transmitting the digital format broadcasting, namely, a reception method of the digital format method. Here, the digital format broadcasting de-modulator 415 de-multiplexes the signals from the apparatus for transmitting the digital format broadcasting into digital data, service information, multiplexer information, optimum sound field information and optimum image quality information.

The optimum sound field information and the optimum image quality information are transmitted to the microcomputer 427. The microcomputer 427 transmits the optimum sound field information and the optimum image quality information to the digital signal processor/image quality controller 419. The digital signal processor/image quality controller 419 controls the sound field and image quality of the digital audio/video codes according to the optimum sound field and image quality information, and outputs the resultant codes to the video decoder 421 and the audio decoder 423.

On the other hand, the digital data are transmitted to the channel decoder 417. The channel decoder 417 generates digital audio/video codes and digital data codes by channel-decoding the digital data according to a preset channel decoding method, namely, a channel decoding method corresponding to the channel encoding method of the channel encoders 315 and 317 of the apparatus for transmitting the digital format broadcasting, outputs the digital audio/video codes to the digital signal processor/image quality controller 419, and outputs the digital data codes to the data decoder 425. The digital signal processor/image quality controller 419 controls the sound field and image quality of the digital audio/video codes from the channel decoder 417 according to the optimum sound field and image quality information, outputs the digital video codes having the optimum image quality to the video decoder 421, and outputs the digital audio codes having the optimum sound field to the audio decoder 423.

The video decoder 421 outputs video service signals by decoding the digital video codes outputted from the digital signal processor/image quality controller 419 with the optimum image quality according to a preset video decoding method, namely, a video decoding method corresponding to the video encoding method of the audio/video encoder 311 of the apparatus for transmitting the digital format broadcasting. The audio decoder 423 outputs audio service signals by decoding the digital audio codes outputted from the digital signal processor/image quality controller 419 with the optimum sound field according to a preset audio decoding method, namely, an audio decoding method corresponding to the audio encoding method of the audio/video encoder 311 of the apparatus for transmitting the digital format broadcasting.

The data decoder 425 outputs data service signals by decoding the digital data codes from the channel decoder 417 according to a preset data decoding method, namely, a data decoding method corresponding to the data encoding method of the data encoder 313 of the apparatus for transmitting the digital format broadcasting.

On the other hand, the microcomputer 427 controls the whole operations of the tuner 413, the digital format broadcast de-modulator 415, the channel decoder 417, the digital signal processor/image quality controller 419, the video decoder 421, the audio decoder 423 and the data decoder 425.

The internal structure of the first apparatus for receiving the digital format broadcasting has been explained with reference to FIG. 4. An internal structure of a second apparatus for receiving digital format broadcasting will now be described with reference to FIG. 5.

FIG. 5 is a block diagram illustrating the internal structure of the second apparatus for receiving the digital format broadcasting in accordance with the present invention.

The second apparatus for receiving the digital format broadcasting attains an optimum sound field and an optimum image quality without modifying the structure of the conventional apparatus for transmitting the digital format broadcasting, namely, by using the conventional apparatus for transmitting the digital format broadcasting. Therefore, the apparatus for transmitting the digital format broadcasting that corresponds to the second apparatus for receiving the digital format broadcasting is identical to the conventional apparatus for transmitting the digital format broadcasting.

As depicted in FIG. 5, the second apparatus for receiving the digital format broadcasting includes an antenna 511, a tuner 513, a digital format broadcast de-modulator 515, a channel decoder 517, a digital signal processor/image quality controller 519, a video decoder 521, an audio decoder 523, a data decoder 525 and a microcomputer 527.

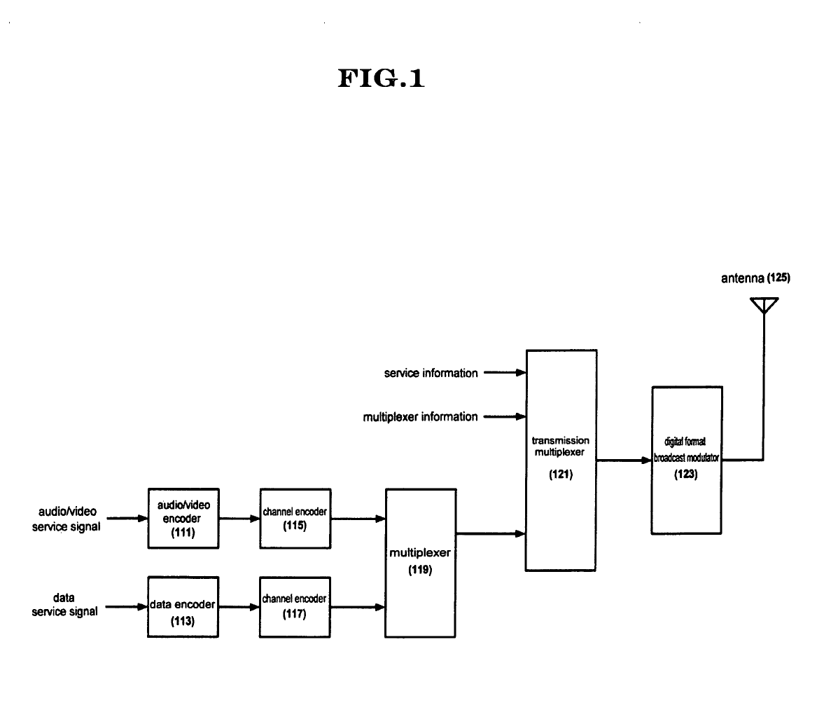

The signals transmitted from the apparatus for transmitting the digital format broadcasting as explained above with reference to FIG. 1 are received by the second apparatus for receiving the digital format broadcasting through the antenna 511. The antenna 511 outputs the received signals to the tuner 513. The tuner 513 tunes the signals from the antenna 511, and outputs the tuned signals to the digital format broadcast de-modulator 515. The digital format broadcast de-modulator 515 de-modulates the signals according to a reception method corresponding to the transmission method of the digital format broadcast modulator 523 of the apparatus for transmitting the digital format broadcasting, namely, a reception method of the digital format method. Here, the digital format broadcasting de-modulator 515 de-multiplexes the signals from the apparatus for transmitting the digital format broadcasting into digital data, service information and multiplexer information.

The service information is transmitted to the microcomputer 527. The microcomputer 527 transmits the service information to the digital signal processor/image quality controller 519. The digital signal processor/image quality controller 519 controls the sound field and image quality of the digital audio/video codes according to the service information, and outputs the resultant codes to the video decoder 521 and the audio decoder 523.

On the other hand, the digital data are transmitted to the channel decoder 517. The channel decoder 517 generates digital audio/video codes and digital data codes by channel-decoding the digital data according to a preset channel decoding method, namely, a channel decoding method corresponding to the channel encoding method of the channel encoders 115 and 117 of the apparatus for transmitting the digital format broadcasting, outputs the digital audio/video codes to the digital signal processor/image quality controller 519, and outputs the digital data codes to the data decoder 525. The digital signal processor/image quality controller 519 controls the sound field and image quality of the digital audio/video codes from the channel decoder 517 according to the service information, outputs the digital video codes having the optimum image quality to the video decoder 521, and outputs the digital audio codes having the optimum sound field to the audio decoder 523.

The video decoder 521 outputs video service signals by decoding the digital video codes outputted from the digital signal processor/image quality controller 519 with the optimum image quality according to a preset video decoding method, namely, a video decoding method corresponding to the video encoding method of the audio/video encoder 111 of the apparatus for transmitting the digital format broadcasting. The audio decoder 523 outputs audio service signals by decoding the digital audio codes outputted from the digital signal processor/image quality controller 519 with the optimum sound field according to a preset audio decoding method, namely, an audio decoding method corresponding to the audio encoding method of the audio/video encoder 111 of the apparatus for transmitting the digital format broadcasting.

The data decoder 525 outputs data service signals by decoding the digital data codes from the channel decoder 517 according to a preset data decoding method, namely, a data decoding method corresponding to the data encoding method of the data encoder 113 of the apparatus for transmitting the digital format broadcasting.

On the other hand, the microcomputer 527 controls the whole operations of the tuner 513, the digital format broadcast de-modulator 515, the channel decoder 517, the digital signal processor/image quality controller 519, the video decoder 521, the audio decoder 523 and the data decoder 525.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

As discussed earlier, the present invention provides the audio/video service and the data service having the optimum sound field and image quality in the digital format broadcasting.

What is claimed is:

1. An apparatus for controlling an image quality and a sound field in digital format broadcasting, comprising:
a first encoder unit for generating digital audio/video codes by encoding audio/video service signals according to a preset audio/video encoding method;
a second encoder unit for generating digital data codes by encoding data service signals according to a preset data encoding method;
a multiplexer for generating digital data by multiplexing the digital audio/video codes and the digital data codes according to a preset multiplexing method;
a transmission multiplexer for generating bit streams by multiplexing the digital data, service information, multiplexer information, and optimum sound field information and optimum image quality information in the digital format broadcasting according to a preset multiplexing method; and
a digital format broadcast modulator for modulating the bit streams according to a transmission method of the digital format broadcasting, and transmitting the modulated bit streams through an antenna.

2. The apparatus of claim 1, wherein the first encoder unit comprises:
an audio/video encoder for encoding the audio/video service signals according to the audio/video encoding method; and
a channel encoder for generating digital audio/video codes by channel-encoding the output signals from the audio/video encoder according to a preset channel encoding method.

3. The apparatus of claim 1, wherein the second encoder unit comprises:
a data encoder for encoding the data service signals according to the data encoding method; and
a channel encoder for generating digital data codes by channel-encoding the output signals from the data encoder according to a preset channel encoding method.

4. An apparatus for controlling an image quality and a sound field in digital format broadcasting, comprising:
a digital format broadcast de-modulator for generating digital data, service information, multiplexer information, and optimum sound field information and optimum image quality information in the digital format broadcasting, by de-modulating received signals according to a de-modulation method of the digital format broadcasting corresponding to a transmission method of the digital format broadcasting;
a channel decoder for generating digital audio/video codes and digital data codes by channel-decoding the digital data according to a preset channel decoding method;
a digital signal processor/image quality controller for controlling an image quality of the digital video codes according to the optimum image quality information, and controlling a sound field of the digital audio codes according to the optimum sound field information;
a video decoder for outputting video service signals by decoding the digital video codes controlled by the optimum image quality information according to a preset video decoding method;
an audio decoder for outputting audio service signals by decoding the digital audio codes controlled by the optimum sound field information according to a preset audio decoding method; and
a data decoder for outputting data service signals by decoding the digital data codes according to a preset data decoding method.

5. A method for controlling an image quality and a sound field in digital format broadcasting, comprising the steps of:
generating digital audio/video codes by encoding audio/video service signals according to a preset audio/video encoding method;
generating digital data codes by encoding data service signals according to a preset data encoding method;
generating digital data by multiplexing the digital audio/video codes and the digital data codes according to a preset multiplexing method;
generating bit streams by multiplexing the digital data, service information, multiplexer information, and optimum sound field information and optimum image quality information in the digital format broadcasting according to a preset multiplexing method; and
modulating the bit streams according to a transmission method of the digital format broadcasting, and transmitting the modulated bit streams through an antenna.

6. The method of claim 5, wherein the step for generating the digital audio/video codes comprises the sub-steps of:
encoding the audio/video service signals according to the audio/video encoding method; and
generating digital audio/video codes by channel-encoding the signals encoded according to the audio/video encoding method according to a preset channel encoding method.

7. The method of claim 5, wherein the step for generating the digital data codes comprises the sub-steps of:
encoding the data service signals according to the data encoding method; and
generating digital data codes by channel-encoding the signals encoded according to the data encoding method according to a preset channel encoding method.

8. A method for controlling an image quality and a sound field in digital format broadcasting, comprising the steps of:
generating digital data, service information, multiplexer information, and optimum sound field information and optimum image quality information in the digital format broadcasting, by de-modulating received signals according to a de-modulation method of the digital format broadcasting corresponding to a transmission method of the digital format broadcasting;
generating digital audio/video codes and digital data codes by channel-decoding the digital data according to a preset channel decoding method;
controlling an image quality of the digital video codes according to the optimum image quality information, and controlling a sound field of the digital audio codes according to the optimum sound field information;
outputting video service signals by decoding the digital video codes controlled by the optimum image quality information according to a preset video decoding method;
outputting audio service signals by decoding the digital audio codes controlled by the optimum sound field information according to a preset audio decoding method; and
outputting data service signals by decoding the digital data codes according to a preset data decoding method.

9. An apparatus for controlling an image quality and a sound field in digital format broadcasting, comprising:
a first encoder unit for generating digital audio/video codes by encoding audio/video service signals according to a preset audio/video encoding method;
a second encoder unit for generating digital data codes by encoding data service signals according to a preset data encoding method;
a multiplexer for generating digital data by multiplexing the digital audio/video codes and the digital data codes according to a preset multiplexing method;
a transmission multiplexer for generating bit streams by multiplexing the digital data, service information and multiplexer information according to a preset multiplexing method; and
a digital format broadcast modulator for modulating the bit streams according to a transmission method of the digital format broadcasting, and transmitting the modulated bit streams through an antenna.

10. The apparatus of claim 9, wherein the first encoder unit comprises:
an audio/video encoder for encoding the audio/video service signals according to the audio/video encoding method; and
a channel encoder for generating digital audio/video codes by channel-encoding the output signals from the audio/video encoder according to a preset channel encoding method.

11. The apparatus of claim 9, wherein the second encoder unit comprises:
a data encoder for encoding the data service signals according to the data encoding method; and
a channel encoder for generating digital data codes by channel-encoding the output signals from the data encoder according to a preset channel encoding method.

12. An apparatus for controlling an image quality and a sound field in digital format broadcasting, comprising:
a digital format broadcast de-modulator for generating digital data, service information and multiplexer information by de-modulating received signals according to a de-modulation method of the digital format broadcasting corresponding to a transmission method of the digital format broadcasting;
a channel decoder for generating digital audio/video codes and digital data codes by channel-decoding the digital data according to a preset channel decoding method;
a digital signal processor/image quality controller for controlling an image quality of the digital video codes according to the service information, and controlling a sound field of the digital audio codes according to the service information;
a video decoder for outputting video service signals by decoding the digital video codes controlled by the service information according to a preset video decoding method;
an audio decoder for outputting audio service signals by decoding the digital audio codes controlled by the service information according to a preset audio decoding method; and
a data decoder for outputting data service signals by decoding the digital data codes according to a preset data decoding method.

13. A method for controlling an image quality and a sound field in digital format broadcasting, comprising the steps of:
generating digital audio/video codes by encoding audio/video signals according to a preset audio/video encoding method;
generating digital data codes by encoding data service signals according to a preset data encoding method;
generating digital data by multiplexing the digital audio/video codes and the digital data codes according to a preset multiplexing method;
generating bit streams by multiplexing the digital data, service information and multiplexer information according to a preset multiplexing method; and
modulating the bit streams according to a transmission method of the digital format broadcasting, and transmitting the modulated bit steams through an antenna.

14. The method of claim 13, wherein the step for generating the digital audio/video codes comprises the sub-steps of:
encoding the audio/video service signals according to the audio/video encoding method; and
generating digital audio/video codes by channel-encoding the signals encoded according to the audio/video encoding method according to a preset channel encoding method.

15. The method of claim 13, wherein the step for generating the digital data codes comprises the sub-steps of:
encoding the data service signals according to the data encoding method; and
generating digital data codes by channel-encoding the signals encoded according to the data encoding method according to a preset channel encoding method.

16. A method for controlling an image quality and a sound field in digital format broadcasting, comprising the steps of:
generating digital data, service information and multiplexer information by de-modulating received signals according to a de-modulation method of the digital format broadcasting corresponding to a transmission method of the digital format broadcasting;
generating digital audio/video codes and digital data codes by channel-decoding the digital data according to a preset channel decoding method;
controlling an image quality of the digital video codes according to the service information, and controlling a sound field of the digital audio codes according to the service information;
outputting video service signals by decoding the digital video codes controlled by the service information according to a preset video decoding method;
outputting audio service signals by decoding the digital audio codes controlled by the service information according to a preset audio decoding method; and
outputting data service signals by decoding the digital data codes according to a preset data decoding method.
